(19) United States
(12) Patent Application Publication
(10) Pub. No.: US 2014/0345440 A1
(43) Pub. Date: Nov. 27, 2014

(54) WIRELESS TUNING DEVICE FOR MUSICAL INSTRUMENTS

(71) Applicant: ONBOARD RESEARCH CORPORATION, Carrollton, TX (US)

(72) Inventor: Arthur David Harvey, Dallas, TX (US)

(21) Appl. No.: 14/457,036

(22) Filed: Aug. 11, 2014

Related U.S. Application Data
(63) Continuation of application No. 13/346,310, filed on Jan. 9, 2012, now abandoned.

(51) Int. Cl. G10G 7/00

(52) U.S. Cl. CPC G10G 7/00
USPC 84/454

(57) ABSTRACT

A musical electronic device to receive a wireless signal modulated with an audio signal originating from a musical instrument, to display useful information for tuning the instrument, and to provide the received audio signal as an output for other musical electronics.

### CROSS-REFERENCE TO RELATED APPLICATION

The present application is a continuation of U.S. patent application Ser. No. 13/346,310, filed Jan. 9, 2013, invented by Arthur David Harvey, and entitled “Wireless Tuning Device for Musical Instruments.”

### TECHNICAL FIELD OF THE INVENTION

The field of the present invention is that of electronic devices with musical application, herein referred to as musical electronics.

### BACKGROUND OF THE INVENTION

The field of the present invention is that of electronic devices with musical application, herein referred to as musical electronics.

Stringed musical instruments such as the guitar require frequent tuning during practice and performance. Instrument tuners of various forms have existed for decades. Typically, modern tuning devices compare the audio signal of a musical instrument to a set of standard musical pitches, and provide feedback to the user to increase or decrease the pitch of the instrument. When the instrument matches a standard pitch within some range of tolerance, the instrument is considered to be in tune.

Wireless musical electronic systems for the transmission of the audio signals generated by musical instruments and voice have also existed for decades. Typically, modern wireless systems convert the analog electrical signal of an instrument into a digital representation of the signal and transmit the digital information to a wireless receiver. The wireless receiver processes the digital representation and reconstructs an analog signal.

The disclosed invention is a musical electronic device for the wireless tuning of musical instruments.

### SUMMARY OF THE INVENTION

The present invention relates to the tuning of electric instruments such as the guitar, bass guitars, and the like. It is an object of the invention to receive a wireless audio signal originating from a musical instrument or electronics connected to an instrument, display useful information for tuning the instrument, and to provide the received audio signal as an output for other musical electronics such as an amplifier, mixer, musical effects processor, or the like.

### DESCRIPTION OF THE DRAWINGS

FIG. 1 is a block diagram of the electronic wireless tuning device according to the preferred embodiment of the invention.

### DETAILED DESCRIPTION OF THE INVENTION

In the following description, the various embodiments of the present invention will be described in detail. However, such details are include to facilitate understanding of the invention and to describe the preferred embodiment of the invention. Such details should not be used to limit the invention to the particular embodiments described because other variations and embodiments are possible while staying within the scope of the invention. Furthermore, although numerous details are set forth in order to provide a thorough understanding of the invention, it will be apparent to one skilled in the art that these specific details are not required to practice the invention. In other instances, details such as well-known methods, electrical circuits, processes, and interfaces are illustrated in block diagram form so as to not obscure the present invention. The transmission source of the received wireless signal has been omitted from the drawings to avoid obscuring the object of the present invention. Furthermore, aspects of the invention may be implemented in hardware, software, firmware, or a combination thereof.

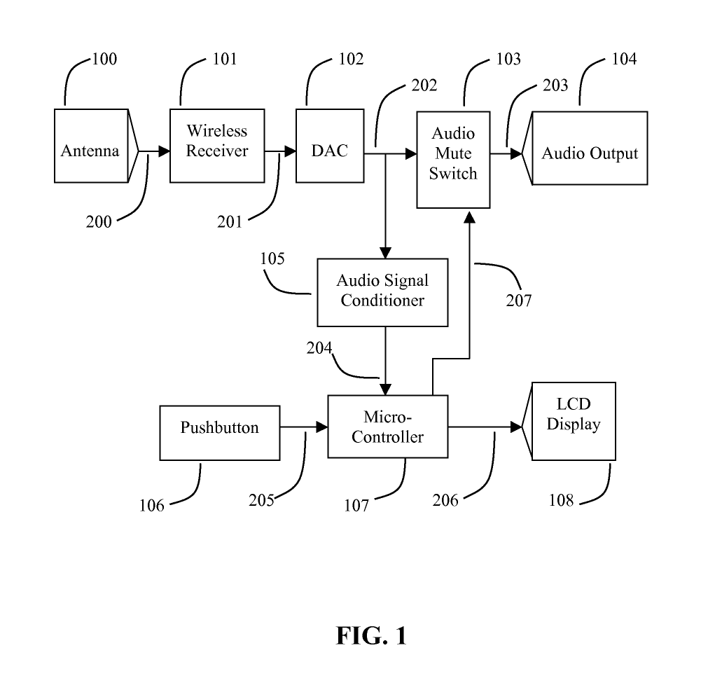

With reference now to FIG. 1, FIG. 1 is a block diagram of a system for the wireless tuning of musical instruments, according to one embodiment of the invention. As shown in FIG. 1, Antenna 100 receives a wireless signal modulated with a representation of the analog signal of an instrument. The Antenna 100 may be integrated on a printed circuit board, a chip antenna, a whip antenna, a wire, or other structure capable of receiving radio frequency energy.

The radio frequency signal received from the Antenna 100 is conveyed to the Wireless Receiver 101 via a connection 200. The connection 200 between the Antenna 100 and the Wireless Receiver 101 may be one or more circuit board traces, a detachable connector, a cable, or other structure designed to convey a radio frequency signal from one physical location to another. In one foreseeable potential future embodiment, the Antenna 100 may be integrated directly into the Wireless Receiver 101, minimizing or removing the need for a separate connection 200.

The Wireless Receiver 101 receives and interprets the signal received by the Antenna 100, conveyed to it by a connection 200. The Wireless Receiver 101 processes and demodulates the radio frequency signal, producing as an output 201 a digital representation of the original instrument signal.

The output 201 of the Wireless Receiver 101 is connected to a Digital to Analog Converter (DAC) 102. The connection 201 may consist of one or more circuit board traces, a detachable connector, a cable, or other structure designed to convey electrical or optical signals from one physical location to another

The Digital to Analog Converter (DAC) 102 receives a digital representation of the original instrument provided by the Wireless Receiver 101 through a connection 201, and converts said representation into an analog reconstruction of the original instrument signal. The output of the Digital to Analog Converter (DAC) 102 is an Audio Signal

In one foreseeable possible future embodiment, the Digital to Analog Converter (DAC) 102 may be integrated into the Wireless Receiver 101, eliminating the need for a connection 201.

In the preferred embodiment, the Audio Signal 202 is a 1-volt (by root-mean-square measurement) analog audio signal. Other signal formats may be used without departing from the scope of the invention.

The Audio Signal 202 is connected to an Audio Mute Switch 103. When actuated, the Audio Mute Switch 103 disconnects the Audio Signal 202 from the connection 203 and Audio Output 104, effectively silencing the output of the invention. When not actuated, the Audio Mute Switch 103 connects the audio signal 202 via a connection 203 to the Audio Output 104. In the preferred embodiment, actuation of the Audio Mute Switch 103 is controlled by a Microcontroller 107, via an electrical control signal 207.

In the preferred embodiment, the Audio Output 104 is a 1-volt (by root-mean-square measurement) analog audio signal provided for external connection on a common ¼ inch audio jack. Alternate audio signal and connector formats may be used without departing from the scope of the invention. One example of such an alternate signal format would be an optical signal provided on an optical fiber connector. Another foreseeable alternate output format is that of a modulated radio frequency signal produced by a radio frequency transmitter device connected to the Mute Switch 103 via a connection 203.

In one possible embodiment, it may not be desirable to have a mute switch, and the Audio Signal 202 produced by the DAC 102 may be connected directly to the Audio Output 104.

In one possible embodiment, it may be desirable to perform additional processing of the Audio Signal 202 produced by the DAC 102 before providing it to the Audio Output 104. Examples of such additional processing include equalization, filtering, addition of distortion, or any other signal modification common to musical electronics. In such embodiments, additional processing circuitry may be added in series at any point between the Wireless Receiver 101 and the Audio Output 204.

The reconstructed Audio Signal 202 is also provided as an input to the Audio Signal Conditioner 105. The Audio Signal Conditioner 105 buffers the Audio Signal 202 so as not to unnecessarily load or degrade the Audio Signal 202, and may include such circuits as filters, automatic gain circuits, comparators, or other common signal processing circuits. The conditioned analog signal 204 is provided to a Microcontroller 107 for further processing.

In the preferred embodiment, software running on the Microcontroller 107 examines the Conditioned Signal 204, determines the fundamental frequency of the Conditioned Signal 204, compares the derived fundamental frequency to a set of standard musical pitches, produces information useful for tuning a musical instrument, and provides said tuning information to a Liquid Crystal Display (LCD) 108 via circuit board connections 206. Tuning information displayed in the preferred embodiment is a musical note with sharp or flat indication. Other tuning information or figures of merit could be provided without departing from the scope of the present invention. Display technologies other than LCD may be utilized without departing from the scope of the present invention.

In the preferred embodiment, the software on Microcontroller 107 also monitors the status of a Pushbutton 106. When the Pushbutton 106 changes state, the software on the Microcontroller 107 actuates the Audio Mute Switch 103 via electrical signal 207. Many alternative input methods exists for Pushbutton 106, such as a footswitch, capacitive touch circuit, motion recognition, or other human interface apparatus. In addition, the Pushbutton 106 may be mechanically or directly coupled to the Audio Mute Switch 103. Additional pushbuttons or user inputs may be added to serve additional functions without departing from the scope of the present invention. Additional actions associated with the user input of the Pushbutton 106 or an alternate interface include turning the LCD display on/off, turning on/off a backlight for the LCD, or switching the output to an alternate audio signal source are possible and do not depart from the scope of the present invention.

1. An electronic device for use in conjunction with a musical instrument, comprising:
an antenna for receiving a radio frequency signal;
a wireless receiver for receiving the radio frequency signal from the antenna, wherein the radio frequency signal is a wireless signal representative of an audio signal output of a musical instrument;
an electronic circuit for deriving a received audio signal from the wireless signal;
an output for providing the received audio signal to external devices;
a second electronic circuit for monitoring the received audio signal and performing a pitch analysis by comparing a fundamental pitch of the received audio signal to standard musical pitches;
a display indicating results of the pitch analysis in notation useful for tuning the musical instrument; and
an enclosure housing the wireless receiver and other electronic circuitry.

2. The electronic device according to claim 1, further comprising a switch capable of disconnecting the received audio signal from the output.

3. The electronic device according to claim 1, further comprising a switch capable of muting or attenuating the received audio signal provided to the output.

4. The electronic device according to claim 1, wherein the received audio signal is further processed or electronically modified prior to the output.

5. The electronic device according to claim 1, wherein the output of the device is a radio frequency transmitter.

6. The electronic device according to claim 1, wherein the second electronic circuit for monitoring the received audio signal and comparing the fundamental pitch of the received audio signal to the standard musical pitches is comprised of a Digital Signal Processor.

7. The electronic device according to claim 1, wherein a plurality of audio signals are derived from one or more wireless signals, and one or more of said plurality of audio signals are provided on at least the output.

8. The electronic device according to claim 1, wherein the comparison of the fundamental pitch of the received audio signal to the standard musical pitches is performed by analog circuitry.

9. The electronic device according to claim 1, wherein the comparison of the fundamental pitch of the received audio signal to the standard musical pitches is performed by digital circuitry.

10. The electronic d vice according to claim 1, wherein the comparison of the fundamental pitch of the received audio signal to the standard musical pitches is performed by a combination of analog and digital circuitry.

11. An electronic device for use in conjunction with a musical instrument, comprising:
an antenna for receiving a radio frequency signal;
a wireless receiver for receiving the radio frequency signal from the antenna, wherein the radio frequency signal is a wireless signal representative of an audio signal output of a musical instrument and a tuning figure of merit;
an electronic circuit for deriving a received audio signal from the wireless signal;
an output for providing the received audio signal to external devices;
a display indicating the tuning figure of merit in notation useful for tuning the musical instrument; and
an enclosure housing the wireless receiver and other electronic circuitry.

12. The electronic device according to 11, wherein a transmitting device monitors the received audio signal, performs pitch analysis, and transmits results of the pitch analysis in addition to the received audio signal of the musical instrument.

13. The electronic device according to claim 11, further comprising a switch capable of disconnecting the received analog audio signal from the output.

14. The electronic device according to claim 11, wherein the received analog signal is further processed or electronically modified prior to output.

15. The electronic device according to claim 11, wherein the output is a radio frequency wireless transmitter.

16. The electronic device according to claim 11, further comprising a second electronic circuit for monitoring the received audio signal and comparing a fundamental pitch of the received audio signal to standard musical pitches which is comprised of a Digital Signal Processor.

17. The electronic device according to claim 11, wherein a plurality of audio signals are derived from one or more wireless signals, and one or more of said plurality of audio signals are provided on at least the output.
